(19) United States
(12) Patent Application Publication
(10) Pub. No.: US 2007/0183345 A1
(43) Pub. Date: Aug. 9, 2007

(54) Managing a home or a small office network

(75) Inventors: Mohammad Fahim, Lone Tree, CO (US); Brion Feinberg, Morganville, NJ (US); Inder S. Gopal, New York, NY (US); Ryan Moats, Omaha, NE (US); Al-Amyn Valliani, Houston, TX (US)

Correspondence Address: William Botjer, PO Box 478, Center Moriches, NY, 11934, US

(73) Assignee: SERENITI, INC., JERSEY CITY, NJ (US)

(21) Appl. No.: 11/348,166

(22) Filed: Feb. 6, 2006

(51) Int. Cl. H04L 12/28

(52) U.S. Cl. 370/254; 370/401

(57) ABSTRACT

A method and a system for managing a network are described. A plurality of agents is deployed in a plurality of devices in the network. A control device in the network controls the network through the plurality of agents. A remote manager, which is external to the network, controls the network through the control device. The remote manager can also control other networks simultaneously through other control devices. Further, a storage registry can maintain records related to the network on either the control device or the remote manager or both. The records maintained in the storage registry can be viewed, queried or modified through a management portal. Authorized users of the network and technical personnel may be given different rights to manage the network, both locally through the control device and from a remote physical location through the remote manager.

### BACKGROUND

The invention relates to computer networks, in general. More specifically, the invention relates to management of networks.

Networks interconnecting multiple computers and other devices have traditionally been used in large offices and organizations. Such networks hereinafter referred to as computer networks, enable handling and sharing of information and other resources amongst the users. Managing computer networks involves complex tasks, such as maintaining records related to the computer networks, addition of new devices in the computer networks, providing new functions or capabilities in the computer networks, and solving any problems related to the computer networks.

Large offices usually employ dedicated personnel especially to manage these computer networks. However, small offices have networks with a small number of devices connected to each other. It is usually not feasible for these small offices to employ dedicated personnel with sufficient expertise to manage networks.

Further, recent technological advancements have enabled connecting devices, apart from traditional computing devices, such as desktop computers and printers, in networks. Examples of such devices include telephones, televisions, refrigerators, microwaves, and even bathtubs. This has enabled formation of networks at homes by inter-connecting such devices to each other and to computing devices. Various methods are available that enable users of a network to manage the network without any specific expertise.

One of the methods enables automatic installation of new devices to a network. According to this method, new devices are automatically installed in the network, without requiring any user intervention.

Another method involves maintaining multiple copies of records related to a network on multiple devices in the network. The network can be managed by changing the records on any of the devices on which the records related to the network are maintained. Any change made in one copy of the records will automatically be updated in the other copies.

Yet another method involves maintaining records related to a network in a central device. Any change in the records maintained on this device is automatically implemented throughout the network. Therefore, the network can be managed from the central device in the network.

However, the methods described above are static and not capable of managing networks with new capabilities, or with increasing complexities. For example, upgrading software in the devices in a network, upgrading router settings or firmware in the network, and installing security patches are a few tasks that usually require technical personnel in the field of network management. Further, the technical personnel are required to be present at physical locations in the proximity of the network. This does not allow active and optimal network management, particularly in small offices and homes, wherein it is inconvenient and dedicated technical personnel might also not be available.

Therefore, there exists a need for a method and a system to enable remote management of networks. The method and the system should enable management of a network from a physical location remote from the physical location of the network. Therefore, the method and the system should eliminate the requirement of dedicated technical personnel to be physically located in proximity of the network. Moreover, the method and the system should enable the technical personnel to simultaneously manage a plurality of such networks from a single physical location.

### SUMMARY

The invention provides a method, a system, a computer program product, and an apparatus for managing a network.

An object of the invention is to provide a system for managing a network including a plurality of devices. The system includes a plurality of agents corresponding to the plurality of devices, the plurality of agents managing the plurality of devices, a control device for controlling the network through the plurality of agents and a remote manager for controlling the network through the control device, from a remote location external to the network.

Another object of the invention is to provide a system for managing a network including a plurality of devices. The system includes a plurality of agents corresponding to the plurality of devices, the plurality of agents managing the plurality of devices, a control device for controlling the network through the plurality of agents, a remote manager for controlling the network through the control device, from a remote location external to the network and a storage registry for maintaining records about the network, the storage registry residing on at least one of the control device and the remote manager.

Yet another object of the invention is to provide a method for managing a network including a plurality of devices. The method included the steps of managing a plurality of devices through a plurality of agents, controlling the network by a control device through the plurality of agents, and controlling the network from a remote location external to the network by a remote manager connected to the control device.

### BRIEF DESCRIPTION OF THE DRAWINGS

The preferred embodiments of the invention will hereinafter be described in conjunction with the appended drawings, which are provided to illustrate, and not to limit the invention, wherein like designations denote like elements, and in which:

FIG. 1 illustrates an environment for managing a network, in accordance with an embodiment of the invention;

FIG. 2 illustrates a system for managing a network, in accordance with an embodiment of the invention;

FIG. 3 illustrates an environment for managing a network, in accordance with an embodiment of the invention and

FIG. 4 is a flowchart that illustrates requisite steps in a method for managing a network, in accordance with an embodiment of the invention.

### DESCRIPTION OF PREFERRED EMBODIMENTS

This invention relates to a system, a method, and a computer program product for managing a network.

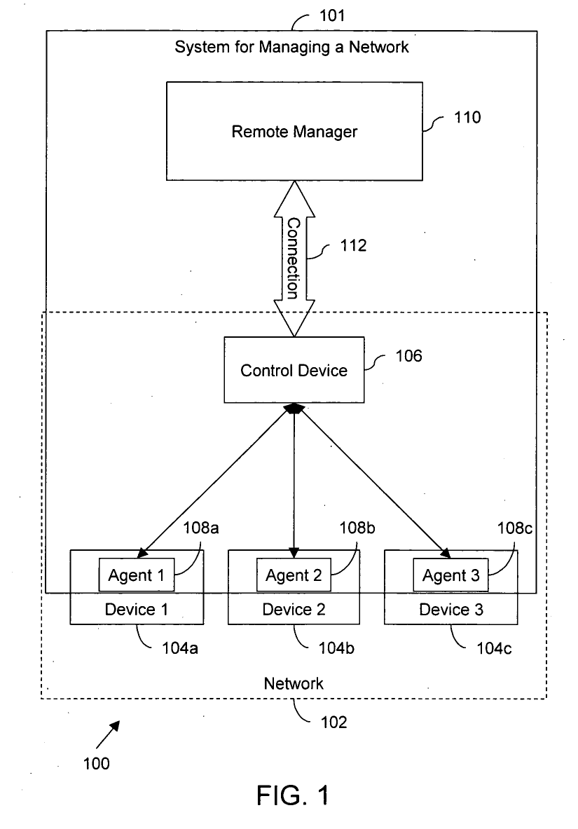

FIG. 1 illustrates an environment 100 for managing a network 102, in accordance with an embodiment of the invention. Network 102 contains a control device 106 and devices 104a, 104b, and 104c. A system 101 for managing network 102 includes agents 108a, 108b, and 108c residing in devices 104a, 104b, and 104c respectively, control device 106 and a remote manager 110 connected by a connection 112 to control device 106.

In various embodiments of the invention, examples of devices 104a, 104b, and 104c include desktop computers, laptops, communication devices, such as Voice Over Internet Protocol (VOIP) phones and mobile phones, Personal Digital Assistants (PDA), printers, home electronic devices, such as televisions, digital audio players and any other devices capable of communicating with each other and being connected together in network 102.

In some embodiments of the invention, network 102 is a home network where devices 104a, 104b, and 104c are located in a home. In certain embodiments, network 102 is an office network, where devices 104a, 104b and 104c are located in an office environment. In other embodiments of the invention, devices 104a, 104b, and 104c can be located in both, a home and an office environment. In different embodiments of the invention, network 102 can be a Local Area Network (LAN), a Wide Area Network (WAN), a Personal Area Network (PAN), Metropolitan Area Network (MAN), and the like.

In certain embodiments of the invention, devices 104a, 104b, and 104c are physically located in single premises, for example a residential unit in an apartment block. In another embodiment, devices 104a, 104b, and 104c are located in different premises in the same building, for example in different residential units in an apartment block. In other embodiment of the invention, devices 104a, 104b, and 104c are located in physically distant locations, for example in different cities.

In other embodiments of the invention, devices 104a, 104b, and 104c in network 102 further form sub-networks among themselves. In certain embodiments of the invention, different sub-networks of network 102 are located in different premises. For example, devices 104a and 104b in network 102 can form a separate sub-network located in one residential unit, while device 104c forms another sub-network that is located in another residential unit.

Devices 104a, 104b, and 104c contain agents 108a, 108b, and 108c respectively. Agents 108a, 108b, and 108c serve to manage devices 104a, 104b, and 104c, respectively. In embodiments of the invention, agents 108a, 108b, and 108c are software programs installed in devices 104a, 104b, and 104c respectively. In other embodiments of the invention, agents 108a, 108b, and 108c are hardware such as peripheral component interconnect (PCI) cards with embedded software. In an embodiment of the invention, agents 108a, 108b, and 108c are Radio Frequency (RF) devices capable of communicating with control device 106.

Agents 108a, 108b, and 108c enable control device 106 to control network 102. In certain embodiments of the invention, control device 106 is an independent device in network 102 and performs only the function of controlling network 102. In other embodiments of the invention, control device 106 co-exists with another device in network 102. For example, control device 102 can co-exist with a router or a central server in network 102. In this case the router or the central server also performs the function of controlling network 102. In an embodiment of the invention, authorized users in network 102 have privileges or rights to control network 102 through control device 106.

In embodiments of the invention, control device 106 can be a separate hardware. For example, control device 106 can be an embedded device in network 102, dedicated to controlling network 102. In other embodiments, control device 106 is an additional hardware in an already existing device in network 102. For example, control device 106 can be an extension card in device 104a in network 102. In certain embodiments of the invention, control device 106 is software in devices 104a, 104b, and 104c in network 102. For example, control device 106 can be implemented as a software module in device 104a.

In some embodiments of the invention, control device 106 is co-located with devices 104a, 104b, and 104c in network 102. For example, control device 106 can be located in the same physical premises as devices 104a, 104b, and 104c. In other embodiments of the invention control device 106 is implemented at a physical location remote from devices 104a, 104b, and 104c. For example, control device 106 can be located in a city different from the location of devices 104a, 104b, and 104c.

Control device 106 enables remote manager 110 to control network 102 via connection 112. In an embodiment of the invention, remote manager 110 is located at a location away from network 102. In embodiments of the invention, a technical person skilled in network management remotely controls network 102 via remote manager 110. In certain embodiments of the invention, remote manager 110 enables authorized users of network 102 to control network 102 through via connection 112.

In some embodiments of the invention, remote manager 110 is a separate hardware in system 101 and is dedicated to controlling network 102. In various other embodiments of the invention, remote manager 110 is an additional hardware in a device, which can also perform tasks other than controlling network 102. For example, manager 110 can be implemented in a central server of a remote network management firm. In other embodiments of the invention, remote manager 110 is implemented as software. In yet other embodiments of the invention, remote manager 110 is a combination of software and hardware. In certain embodiments of the invention, both control device 106 and remote manager 110 are implemented in the same device.

In different embodiments of the invention, remote manager 110 is always connected to control device 106. In such cases, remote manager 110 is able to control network 102 in real-time through control device 106. Further, in other embodiments, control device 106 in network 102 is powered on at all times. This enables control device 106 to continuously monitor and control network 102.

In certain embodiments of the invention, connection 112 is through a dedicated communication line between control device 106 and remote manager 110. Examples of dedicated communication line include a dedicated telephone or a leased line. In alternative embodiments of the invention, connection 112 is through a public or open communication protocol, for example, the Internet. In other embodiments of the invention, connection 112 is through two or more communication pathways. In this case, connection 112 between control device 106 and remote manager 110 can be maintained through one pathway if other communication pathways are interrupted.

In some embodiments of the invention, connection 112 between control device 106 and remote manager 110 is a secure connection, which uses encryption technology known to a person ordinarily skilled in the art. In various embodiments, connection 112 is a secure connection employing Secure Socket Layer (SSL) technology. This enables secure control of network 102 from remote locations even via public communication pathways, such as the Internet.

In certain embodiments of the invention, system 101 for managing network 102 further includes one or more storage registries for maintaining records related to network 102. In an embodiment of the invention, a storage registry is maintained on control device 106. In some embodiments of the invention, a storage registry is maintained on remote manager 110. In other embodiments, storage registries are maintained on control device 106 as well as on remote manager 110.

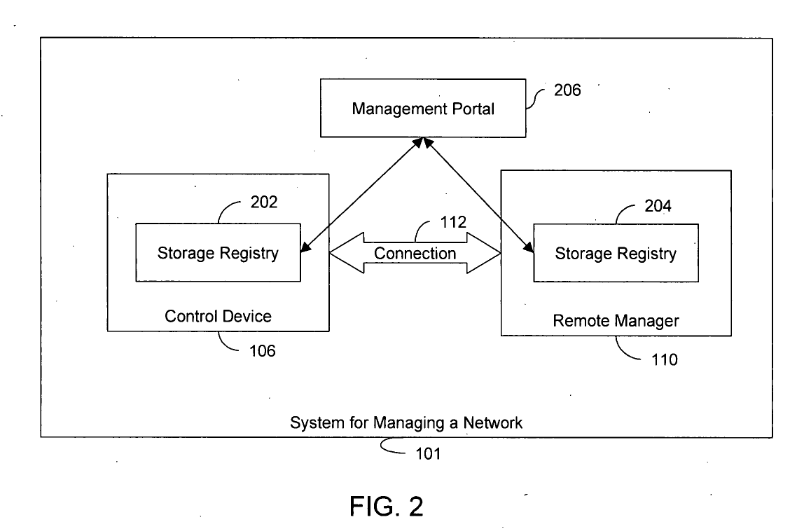

FIG. 2 illustrates system 101 for managing network 102, in accordance with an embodiment of the invention. In accordance with this embodiment, system 101 further includes a storage registry 202, which is maintained in control device 106, a storage registry 204 maintained in remote manager 110, and a management portal 206.

Storage registries 202 and 204 maintain records related to network 102. In an embodiment of the invention, storage registries 202 and 204 maintain records related to network 102 in a device-independent manner. In this case, the records are maintained for all types of devices in network 102 in a consistent and uniform manner. Therefore, the records maintained in relation to one type of device in network 102 will have a format identical to the format of the records maintained for another type of device in network 102.

In certain embodiments of the invention, storage registries 202 and 204 are viewed, queried, and modified through management portal 206. Any modifications of these records are automatically implemented throughout network 102. Therefore, management portal 206 enables monitoring and control of network 102. In other embodiments, management portal 206 is implemented through control device 106. In various other embodiments of the invention, management portal 206 is implemented through remote manager 110. In some embodiments of the invention, management portal 206 is implemented through both control device 106 and remote manager 110. Management portal 206 can enable monitoring and control of network 102 for the authorized users of network 102 as well as the technical personnel. In other embodiments of the invention, management portal 206 offers different interfaces for the authorized users and the technical personnel for network management, based on individual authorizations. For example, an authorized user in network 102 who is allowed to install new software only on device 104a and not on any other device in network 102 can be provided an interface that offers him access only to the above feature.

In certain embodiments of the invention, remote manager 110 is connected to one or more control devices other than control device 106. These one or more control devices can be present in one or more networks other than network 102.

In different embodiments of the invention, system 101 for managing a network can be upgraded on a continuous basis. In embodiments of the invention, remote manger 110, control device 106, and agents 108a, 108b, and 108c can be upgraded independently of each other. For example, different components of systems 101 can be upgraded when new versions of the different components are available. In an embodiment of the invention, the upgrades can be performed through the Internet. In certain embodiments, where remote manager 110 is implemented in the central server of a remote network management firm, control device 106 and agents 108a, 108b, and 108c can be upgraded by the remote network management firm automatically through connection 112.

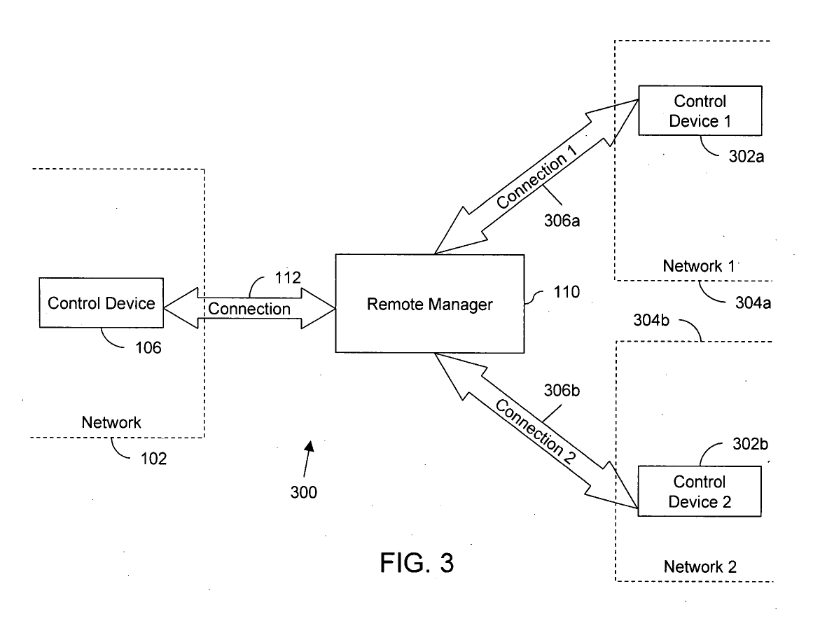

FIG. 3 illustrates an environment 300 for managing network 102, in accordance with an embodiment of the invention. According to the embodiments of the invention, remote manager 110 is connected, through connections 306a and 306b, to control devices 302a and 302b present in networks 304a and 304b, respectively. Remote manager 110 can, therefore, control networks 304a and 304b apart from network 102. This control is enabled through control devices 302a and 302b. In different embodiments of the invention, remote manager 110 simultaneously controls networks 102, 304a and 304b, through control devices 106, 302a and 302b, respectively.

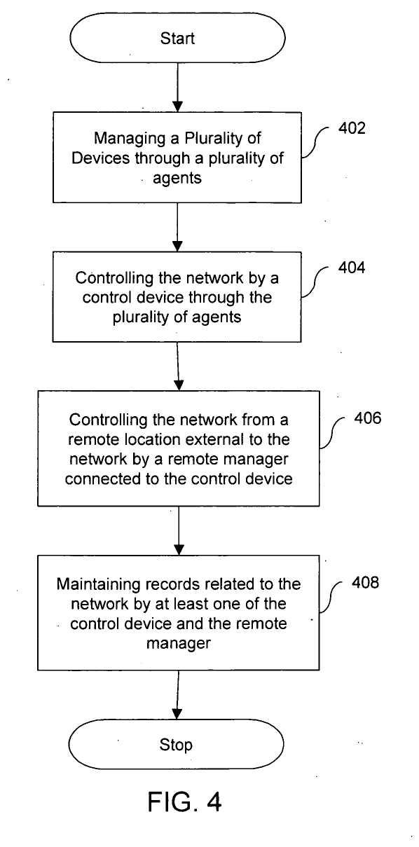

FIG. 4 is a flowchart illustrating a method for managing network 102, in accordance with the embodiments of the present invention.

At step 402, agents 108a, 108b and 108c manage devices 104a, 104b, and 104c respectively. Managing of devices 104a, 104b, and 104c by agents 108a, 108b, and 108c respectively includes functions, such as configuring, managing and updating software installed on devices 104a, 104b, and 104c. In certain embodiments of the invention, agents 108a, 108b, and 108c also provide an interface to control and manage the functions performed by devices 104a, 104b, and 104c. In other embodiments, agents 108a, 108b, and 108c aid in discovering and installing new devices in network 102. For example, if a new device is added to network 102, a new agent is introduced into this new device. The new agent then configures and installs the new device in network 102. Additionally, agents 108a, 108b, and 108c can automatically communicate with control device 106 when devices 104a, 104b, and 104c are powered on. In certain embodiments, devices 104a, 104b, and 104c are configured by control device 106 through agents 108a, 108b, and 108c at the time of power on initialization. For example, when device 104a is powered on in network 102, agent 108a is automatically activated. Agent 108a then establishes communication with control device 106. Further, agent 108a can enable network settings, which are maintained in storage registries 202 and 204, to be implemented in device 104a. Therefore, agent 108a can also enable automatic configuration of device 108a in network 102 when device 104a is powered on.

At step 404, control device 106 controls network 102 through agents 108a, 108b, and 108c. In an embodiment of the invention, control device 106 monitors functions in network 102. For example, control device 106 can monitor the communication between devices 104a, 104b and, 104c in network 102, and also maintain records regarding the same. In other embodiments of the invention, control device 106 manages devices 104a, 104b, and 104c through instructions, which are executed by agents 108a, 108b, and 108c. In yet other embodiments of the invention, control device 106 supports old devices in network 102, in which agents cannot be introduced due to non-compatibility. In such cases, control device 106 can enable the functionality of agents to be available for the old devices through a proxy interface that mimics the functionality of agents. Control device 106 establishes connection 112 with remote manager 110, to enable remote manager 110 to control network 102.

At step 406, remote manager 110 controls network 102 through control device 106. In some embodiments of the invention, remote manager 110 performs diagnostic tests on network 102, to detect and solve any problems in network 102. For example, remote manager 110 can test for speed of connection between devices 104a, 104b, and 104c in network 102. In other embodiments, remote manager 110 also provides automatic alerts for users of network 102, in case any potential or actual errors and problems are detected in network 102.

In certain embodiments of the invention, remote manager 110 provides an overview of configuration information about network 102 to the technical person remotely controlling network 102 through remote manager 110. For example, remote manager 110 can provide a list with the type of devices 104a, 104b, and 104c in network 102 along with a topology of their connections. Additionally, in other embodiments of the invention, remote manager 110 automatically keeps a record of software installed on control device 106, and on devices 104a, 104b, and 104c. In such cases, remote manager 110 automatically installs any updates for the software or patches to fix any flaws in the software. In certain other embodiments, remote manager 110 also tracks subscriptions or any other orders placed by the users of network 102. For example, remote manager 110 can keep track of any special software ordered by a user in network 102, and intimate the user when that software is delivered.

In embodiments of the invention, remote manager 110 enables upgrading control device 106 and agents 108a, 108b, and 108c. For example, new capabilities and features can be provided in control device 106 and agents 108a, 108b, and 108c by remote manger 110. Further, remote manager 110 can also be upgraded with new capabilities and features.

At step 408, at least one of control device 106 and remote manager 110 maintain records related to network 102. In various embodiments of the invention, records related to network 102 are maintained in storage registries 202 and 204. In other embodiments of the invention, storage registries 202 and 204 maintain records related to devices 104a, 104b, and 104c in network 102. For example, storage registries 202 and 204 can maintain records about the identification of a device, its network address, current status of the device, and the time it was last synchronized. In yet other embodiments of the invention, storage registries 202 and 204 maintain records about capabilities of devices 104a, 104b, and 104c in network 102. For example, storage registries 202 and 204 can maintain records regarding the type of a device, its hardware configuration such as processor speed, memory, and storage, and the software installed on the device along with the versions. In different embodiments, storage registries 202 and 204 also maintain records related to users of network 102. For example, storage registries 202 and 204 can maintain records for the users in network 102, their access privileges on devices 104a, 104b, and 104c, their preferences, and their authorizations to control network 102 through control device 106.

In different embodiments of the invention, records in storage registries 202 and 204 are maintained on a real-time basis. In this case, the records are modified as soon as there is any change in network 102, device or user configuration. In other embodiments of the invention, storage registries 202 and 204 are updated at regular intervals.

In some embodiments of the invention, storage registries 202 and 204 maintain identical records. In other embodiments, storage registries 202 and 204 can synchronize the records with each other at regular intervals. In embodiments of the invention, the records can be synchronized whenever there is a change in either of storage registries 202 and 204. Further, in other embodiments, storage registries 202 and 204 restore each other's records in case records in one get damaged. For example, if records in storage registry 202 are damaged, then they can be restored by records in storage registry 204, and vice versa.

In the embodiments of the invention, a storage registry is either maintained on control device 106 or on remote manager 110. In this case, the storage registry can be accessed by the other through connection 112. For example, if only storage registry 202 in control device 106 is maintained, then remote manager 110 can access the records in storage registry 202 through connection 112, and vice versa.

It will be apparent to a person skilled in the art that embodiments of the invention enable remote management of a network without the requirement of dedicated personnel for network management to be physically co-located with the network. Users of the network are not required to be technically skilled to manage networks. Further, the invention enables secure management of the network from a remote location. The invention also enables managing multiple networks from a common physical location. Additionally, comprehensive records related to the network can be maintained at a central point in the network. These records can also be maintained in duplicate at a location that is at a physically remote from the network. Therefore, in case the records get damaged at one of the locations, they can be automatically restored from the other location. These records also enable comprehensive management of the network from the central point since the network can be controlled by modifying the records maintained at the central point. The invention also enables continuous upgrading of the system for managing the network. Hence, the system for managing the network is dynamic and capable of supporting new technologies and types of devices in the domain of networking.

The system for managing a network, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of programmable instructions that are stored in one or more storage elements, in order to process input data. The storage elements may also hold data or other information as desired. The storage element may be in the form of an information source or a physical memory element present in the processing machine.

The programmable instructions may include commands that instruct the processing machine to perform specific tasks such as the steps that constitute the method of the present invention. The method and systems described can also be implemented using only software programming or using only hardware or by a varying combination of the two techniques. The present invention is independent of the programming language used and the operating system in the computers. The instructions for the invention can be written in all programming languages including, but not limited to ‘C’, ‘C++’, ‘Visual C++’ and ‘Visual Basic’. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. The invention can also be implemented in all operating systems and platforms including, but not limited to, ‘Unix’, ‘DOS’, and ‘Linux’.

The programmable instructions can be stored and transmitted on computer readable medium. The programmable instructions can also be transmitted by data signals across a carrier wave. The present invention can also be embodied in a computer program product comprising a computer readable medium, the product capable of implementing the above methods and systems, or the numerous possible variations thereof.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A system for managing a network comprising a plurality of devices, the system comprising:
a. a plurality of agents corresponding to the plurality of devices, the plurality of agents managing the plurality of devices;
b. a control device for controlling the network through the plurality of agents; and
c. a remote manager for controlling the network through the control device, from a remote location external to the network.

2. The system according to claim 1, wherein each of the plurality of devices is selected from a group comprising a computer, a printer, a personal digital assistant (PDA), a digital device, a home electronic device, and a communication device.

3. A system according to claim 1 further comprising a storage registry for maintaining records about the network, the storage registry residing on at least one of the control device and the remote manager.

4. The system according to claim 3, wherein the records maintained in the storage registry relate to at least one of network configuration, network monitoring, one or more of the plurality of devices, and users of the network.

5. The system according to claim 3, wherein the storage registry maintains the records in a device-independent form.

6. The system according to claim 3, wherein storage registries reside on both the control device and the remote manager.

7. The system according to claim 6, wherein the storage registries maintain identical records.

8. The system according to claim 3 further comprising a management portal that enables viewing, querying, and modification of the records maintained in the storage registry.

9. The system according to claim 1, wherein the plurality of devices in the network are physically located within single premises.

10. The system according to claim 1, wherein the network is selected from a group consisting of a home network and a small office network.

11. The system according to claim 1, wherein the remote manager is always connected to the control device.

12. The system according to claim 1, wherein the remote manager is connected to the control device through a secure connection.

13. The system according to claim 1, wherein the control device is always switched on in the network.

14. The system according to claim 1, wherein the remote manager is connected to one or more control devices present in networks different from the network, wherein the remote manager is capable of controlling the networks different from the network through the more or more control devices.

15. A system for managing a network comprising a plurality of devices, the system comprising:
a. a plurality of agents corresponding to the plurality of devices, the plurality of agents managing the plurality of devices;
b. a control device for controlling the network through the plurality of agents;
c. a remote manager for controlling the network through the control device, from a remote location external to the network; and
d. a storage registry for maintaining records about the network, the storage registry residing on at least one of the control device and the remote manager.

16. A method for managing a network comprising a plurality of devices, the method comprising the steps of:
a. managing a plurality of devices through a plurality of agents;
b. controlling the network by a control device through the plurality of agents; and
c. controlling the network from a remote location external to the network by a remote manager connected to the control device.

17. The method according to claim 16 further comprising the step of maintaining records relating to the network by at least one of the control device and the remote manager.

18. The method according to claim 17, wherein the records are maintained in a device independent manner.

19. The method according to claim 17 further comprising the step of synchronizing the records between the control device and the remote manager, if the records are maintained by both, the control device and the remote manager.

20. A computer program product for managing a network, the network comprising a plurality of devices, the computer program product comprising:
a. a machine-readable medium, the machine-readable medium comprising:
i. one or more instructions for managing a plurality of devices through a plurality of agents;
ii. one or more instructions for controlling the network by a control device through the plurality of agents; and
iii. one or more instructions for controlling the network from a remote location external to the network by a remote manager connected to the control device.

21. An apparatus for managing a network, the network comprising a plurality of devices, the apparatus comprising:
a. one or more processing systems, a processing system including a processor coupled to a display and user input device; and
b. a machine-readable medium, the machine-readable medium including instruction for managing a network, the machine readable medium comprising:
i. one or more instructions for managing a plurality of devices through a plurality of agents;
ii. one or more instructions for controlling the network by a control device through the plurality of agents; and
one or more instructions for controlling the network from a remote location external to the network by a remote manager connected to the control device.
